(19) United States
(12) Patent Application Publication
(10) Pub. No.: US 2005/0192029 A1
(43) Pub. Date: Sep. 1, 2005

(54) Method and device for determining the position of terminal in a cellular mobile radio network

(75) Inventors: Clemens Aigner, Wien (AT); Peter Boehm, A-Willendorf (AT); Manfred Otto, Wien (AT)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Aktiengesellschaft

(21) Appl. No.: 11/056,301

(22) Filed: Feb. 11, 2005

(30) Foreign Application Priority Data
Feb. 26, 2004 (DE) 10 2004 009 291.5

(51) Int. Cl. H04Q 7/20

(52) U.S. Cl. 455/456.5; 455/456.1

(57) ABSTRACT

Method for determining the position of a terminal (14) in a cellular mobile radio network (10). with network measurements being executed in the terminal (14) for selection of a service cell (CEL), with the following steps: transfer (S2) of a measurement data request message from a position determination server (16) to the terminal (14), reading out (S3) of measurement data determined by the network measurements from a measurement data memory (40) in the terminal (14) in response to the request message, transfer (S4) of a response message with the read out measurement data from the terminal (14) to the position determination server (16), calculation (S5) of the position of the terminal (14), based on the measurement data transferred, in the position determination server (16).

### CROSS REFERENCE TO RELATED APPLICATIONS

This application claims priority to the German application No. 10 2004 009 291.5, filed Feb. 26, 2004 which is incorporated by reference herein in its entirety.

### FIELD OF INVENTION

The invention relates to a method and an arrangement for determining the position of a terminal in a cellular mobile radio network.

### BACKGROUND OF INVENTION

The major characteristic of a mobile radio network lies in the fact that a subscriber can use telecommunication services from any given location within the service area. In cellular mobile radio networks in particular, such as GSM, GPRS or UMTS networks, various IN services are known for which the functionality is linked to the position of the subscriber, and which thereby offer the user added value compared to pure mobile telephony.

Examples of such Location Based Services (LBS) also known as Location Based Applications are:
Emergency call with automatic transfer of the current position,
Disaster warnings to all mobile radio subscribers currently located in an area involved,
Position-dependent billing, so that for example more favorable charges can be calculated for a private individual in their home area or for a company employee at their place of work,
Traffic monitoring or tracing the positions of motor vehicles (e.g. taxis or trucks) and transport goods by a control center.

It is to be expected that in future location-based information services too will continue to increase in importance.

For all LBS the position of a terminal or a number of terminals must be determined, said terminals being able to be both mobile telephones and also computers or microprocessors equipped with suitable radio devices. The simplest method is based on the cell in which the mobile radio unit is located being known in the mobile radio network. This does not require any modification to the mobile radio terminal. In the core areas of cities, where the sizes of the cell radii are in the range of a few hundred meters, this already allows position determination to be used for many purposes. In rural areas with large cells this SAI (Service Area Identity” method is however too inexact for numerous applications.

The SAI method can be refined by measuring the time needed for the transfer of signals from the base station of the cell to the terminal and back again, i.e. the Round Trip Time (RTT). Base station here is taken to mean the transmit/receive system of a base station, i.e. the Base Transceiver Station (BTS). With the SAI+RTT method a precision in the positioning of around 100 m in a strip-shaped transmit zone around the base station is possible.

A further known method, in which the terminals do not have to be modified in any way, consists of measuring the arrival times of a signal transmitted from a terminal at a number of known locations. To this end what are known as Location Measurements Units (LMUs) are arranged at several locations in the network. These can be installed at the site of a base station or also at any other given location.

To determine a position, the terminal is caused by a corresponding message to send what are known as handover access bursts for example. At least three LMUs measure the arrival times of these bursts and forward their measurement data to a device in the mobile radio network, the Mobile Location Center (MLC). From the difference between two arrival times in each case and the known positions of the associated LMUs, the MLC can conclude that the mobile station is located on a specific hyperbola running between the LMUs. The position of the terminal is determined from the intersections of a number of hyperbolas. Although these OTD (Observed Time Difference) methods allow accuracies of the order of magnitude of 30 m, the major outlay is a disadvantage which manifests itself for the network operator in the need to install a plurality of LMUs.

Determining a terminal's position by measuring arrival times of signals is also possible with terminals modified for this purpose. With this E-OTD (Enhanced-OTD) method the terminal measures the difference between the arrival times of specific signals radiated by a number of base stations. The position can be determined from the measured time differences if either the measured signals are radiated asynchronously or the time difference between the times of transmission is known. E-OTD methods also require additional outlay in that the base stations must be embodied to transmit the additional signals. The mobile radio device must have a significant processing capacity to be able to execute the position determination.

A further class of methods for position determination uses GPS (Global Positioning System), with the terminals having to be equipped with a GPS receiver. Positioning by means of GPS (and in future with the European GALILEO system) offers a very high measurement precision of 10 m or less. However for these methods there must be adequate receive levels (line-of-sight contact) from at least four satellites. This requirement is especially critical within buildings or in narrow enclosed streets. In addition a terminal is rendered not inconsiderably more expensive by the GPS receiver. Micro and pico cells are also provided for the UMTS networks still being set up, said cells ensuring service within the interior of buildings and in the center of large cities. This makes all positioning methods based on the radio cells more exact in proportion to the cell sizes.

### SUMMARY OF INVENTION

Compared to this prior art, the object of the invention is to propose a method and an arrangement for determining the position of a terminal in a cellular mobile radio network which make highly accurate positioning possible and simultaneously minimize the number of the additional devices or equipment required in the network and in the terminals.

This object is achieved by the claims.

A significant idea behind the invention lies in the fact that for position determination measurement data is included which does not have to be determined by the transfer and measurement of additional signals between base stations and terminal. Instead data should be advantageously included which is available in any event in the terminal, and for which the transfer of this information to a centrally or decentrally located device for further calculation and administration can be undertaken without additional outlay and with the least possible load on the network infrastructure. If this type of data is requested from the terminal, a position of the terminal can be determined in the correspondingly embodied device in the network.

In concrete terms a method is proposed in which in a first step a measurement data request message is transferred from a position determining server to the terminal. The position determining server can be a specific version of an MLC, for example of a gateway MLC.

In a second step measurement data which was created by network measurements for selecting a service cell in the terminal can be read out of a measurement data memory as a response to the request message. In particular this involves network measurements which are conducted on an ongoing basis in the terminal.

In a further step the measurement data read out from the terminal is transferred to the position determining server in the form of a measurement data response message. Finally the position of the terminal is computed in the position determining server and this is done on the basis of the measurement data transferred. Furthermore field strength models can be included such as those known from network planning.

For this method no additional processing capacity is needed in the network and only slight modification at the terminal, in the control software for example; thus for example no additional GPS receiver needs to be installed. The only requirement is for the measurement data which (as standardized in the 3GPP method) arises in any event on network measurements for selection of a service cell, to be stored in a form enabling it to be read out and transferred to the position determination server For example the data can be read out from the memory of the terminal and transferred to the position determination server using a data channel (in a GPRS network for example) using the TCP/IP interface.

Instead of numerous LMUs which have to be installed distributed throughout the network, only one additional processing computer has to be implemented in the network. This enables a clear cost saving to be made in the network infrastructure. The MLCs too are to a large extent dispensable, serving MLCs can be dispensed with entirely, as can parts of the gateway MLCs which are not needed for the position determination server.

Using an IP data connection allows the complex SS7 connection required in the IT environment which is expensive because of its specific hardware to be bypassed, and furthermore communication between position determination server and terminal to be greatly simplified compared to known methods. Finally the method in accordance with the invention also requires only minimum additional payload channel network traffic.

In a preferred embodiment of the method in accordance with the invention the measurement data relates to the field strengths at least one base station of the mobile radio network. The field strength or the receive level of a base station at the location of the terminal is a significant entry parameter for the method for cell selection, which is performed by each terminal when switched on for example. This field strengths are thus present in the terminal in any event. Conclusions can be drawn from this about the distance between base station and terminal when the transmit power of the base station as well as if necessary further data, such as beam form and direction of the transmit antenna of base stat ion are known.

In an especially preferred embodiment of the invention the measurement data further relates to the cell ID of the cell serviced by the base station. The field strength and the cell ID are stored here in an assignment to one another in the measurement data memory. If this measurement data is transferred to the position determination server the latter can use the cell ID to record the geographical position of the base station or request the position of other devices of the mobile radio network. From the field strength of the base station at the location of the terminal, i.e. the receive level, (for a known transmit power of the base station) the mutual displacement and thereby the area in which the terminal is located can then be calculated.

In a further embodiment of the method the measurement data relates to the cell in which the terminal is currently located, and/or to cells adjacent to this one. Usually a terminal measures at least the field strength of the base station from which the terminal is serviced as well as the receive level of the adjacent base stations, typically a total of around three to seven stations. If this data, or a part of it is transmitted to the position determination server, said server can determine the position of the terminal with correspondingly higher accuracy. In individual cases it can be entirely sufficient to include in the calculation only the field strength of the base station serving the terminal or that base station which is closest to the terminal. This applies for example if the transmit antenna of the base station exhibits a very marked directional characteristic. In this case the position can be determined with few errors from just one field strength.

In further embodiments of the invention the measurement data is advantageously transferred over a connection from the terminal to the position determination server. It is for example particularly simple to set up a connection in the GPRS or UMTS networks and this can also be done with appropriately configured terminals without active input by the user. Provided the user indicates his agreement by corresponding configuration of the terminal, the position of the terminal can thus be determined at any time in a simple manner without his direct involvement.

In further embodiments of the method in accordance with the invention, for access to the position determination server in order to request the computed position of the terminal in this way, an access authorization is checked by the position determination server. In this case for example the procedures described in the OMA (Open Mobile Alliance, in the Location or Privacy Subgroup in particular) can be employed.

This allows a rapid position determination to be obtained, since authorization requests to the HLR or HSS (e.g. via Any Time Interrogation, ATI) can be avoided. Naturally it is also possible to implement the position determination server at an AA (Authentication/Authorization) server in order to make simple use of its procedures for checking access authorizations. Similarly the position determination server can also use methods known per se, as employed in AA servers for authentication. To do this the applications can if necessary be registered at the position determination server.

With known OTD methods a request for a position determination from a unit or application in the mobile radio network or an external network initially reaches the gateway MLC (GMLC). This determines the (Location Area) of the subscriber at the HLR or HSS (for GSM or UMTS networks) and checks whether the application is authorized to request the position of the subscriber. The gateway MLC forwards a valid request to a Serving MLC. This selects the LMUs, calculates the position from the measurement data supplied and estimates the associated accuracy. The result is then returned to the application. As can be seen from this illustration, the network latency times are also not insignificant for a few of the known methods, since a comprehensive message traffic is required for determining the position. An embodiment of a position determination server in accordance with the invention in which the latter is embodied for checking an access authorization can reduce these latency times.

In a embodiment of the method in accordance with the invention the calculated position is especially transferred to the terminal which is registered for this in the position determination server. This is useful for applications which run on the terminal. On the basis of the position data made available to it, this can explicitly request further data obtained locally from a memory in the terminal or from the mobile radio network.

An arrangement for determining the position of a mobile radio terminal in a cellular mobile radio network initially features a function block for network measurements in the terminal which is embodied to perform network measurements to select a service cell. Furthermore there is a measurement data memory available for buffering measurement data determined by the network measurements. In accordance with the invention there is also a measurement request function block in the terminal and a position determination server in the mobile radio network or at the operator of the mobile radio network.

The measurement request function block is embodied to evaluate a measurement data request message received from the position determination server. Furthermore it is embodied to read measurement data out of the measurement data memory as a reaction to this evaluation and to create a measurement data response message which relates to the measurement data read out, as well as to transmit the response message to the position determination server.

The position determination server is embodied to create the measurement data request message and transmit it to the terminal, as well as to receive and evaluate the measurement data response message transferred from the terminal. This especially includes extracting the transferred measurement data and, based on the transferred measurement data, calculating the position of the terminal.

In a further embodiment the position determination server, in close cooperation with in the GMLCs of different network operators, can also perform the inbound and outbound roaming specified in the OMA.

In an especially preferred embodiment of the arrangement the position determination server is embodied especially to evaluate measurement data relating to the field strength of at least one base station and the cell ID of the cell serviced by this base station. In a further development of the arrangement the position determination server is embodied to access position information of base stations or to calculate this information, and to calculate the position of the terminal based on this base station position information.

In an advantageous embodiment of an inventive arrangement the measurement request function block in the terminal contains a Java application. This allows at least one part of the functionality of the measurement request function block to be implemented particularly simply. Many modern terminals are based on Java applications so that the addition of a further application is possible with little effort. Thus a Java application in accordance with the invention can be downloaded quite simply onto the terminal.

In further embodiments of an inventive arrangement a Java runtime environment is implemented on the terminal, in conjunction with which the measurement request function block executes. Java runtime environments specifically for terminals are known, for example the J2ME (Java 2 P1atform, Micro Edition) technology. Such an environment provides the essential functionalities for mobile applications, including user interface, functionalities for connection with the network, local data storage and application management. A series of APIs are provided for related applications. In this type of environment the method in accordance with the invention can be advantageously implemented with especially low outlay. Thus for example it is possible especially simply to establish an IP connection between position determination server and the measurement request function block via which the measurement data is transmitted.

### BRIEF DESCRIPTION OF THE DRAWINGS

Further aspects, advantages and useful features of the invention are laid down in the dependent claims, as well as the description of exemplary embodiments of the present invention given below. The figures show:

FIG. 1 a schematic of a cellular mobile radio network in which the method in accordance with the invention is executed;

FIG. 2 a simplified network architecture of an inventive mobile radio network;

FIG. 3 a simplified architectural scheme of a mobile radio network with position determination servers as well as the functional layout of a terminal embodied in accordance with the invention;

FIG. 4 a message flow diagram which typically illustrates the message flow in accordance with an embodiment of the invention.

Elements which are the same or have the same effect are shown by the same reference symbols in all the Figures.

### DETAILED DESCRIPTION OF INVENTION

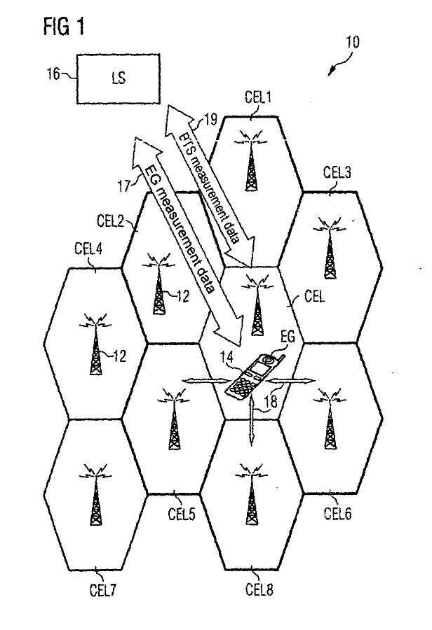

The mobile radio network 10 shown schematically in FIG. 1 can be a GSM, GPRS, UMTS or also TETRA (TErrestial TRunked Radio) network or similar cellular mobile radio network. This network 10 features a plurality of cells CEL and CEL1-CEL8. Each of these cells is serviced by one of the symbolically indicated base stations 12. The schematic diagram of FIG. 1 shows all cells as having the same size and form, but in actual fact the mobile radio cells can have quite different dimensions. The base stations 12 (i.e. the BTSs of the base stations) do not have to be located in the center of a cell but, depending on the beam form of the transmit antenna of the base station can be located at one edge or corner of the cell to be serviced for example.

In a cell CEL of the mobile radio network 10 there is a terminal 14. After the terminal 14 is switched on a suitable radio cell must first be found for the service provision before the user can begin and accept calls. For this purpose the terminal 14 has conventional cell selection procedures.

To select a cell the terminal 14 initially records the receive level of a plurality of frequency carriers. For this purpose the terminal 14 can for example refer back to a list of frequency carriers which may be stored on the SIM card belonging to the last cell visited and to its neighbors. If such a list is not available the terminal 14 must scan through all possible carrier frequencies, i.e. those specified by the mobile radio standard. In the example of the FIG. 1 the terminal 14 could measure the receive level or field strengths of the base stations of the cells CEL, CEL1-CEL8.

The carrier frequencies are stored according to field strength, sorted in the form of a list in the terminal 14. Starting at the strongest measured receive level, the terminal subsequently executes further known methods to synchronize itself with the mobile radio network and if necessary prepare a connection setup. If the receive level of the base station 12 falls below a critical value the terminal 14 does not include its measured field strength in the list of the measurement data. In the example network in FIG. 1 this might involve the base stations of the cells CEL4 and CEL7 remote from the terminal 14.

As well as pointing to the field strengths of the base stations of the cells CEL, CEL1 to CEL8, the list points to the associated cell IDs. This cell identification is for example radiated in a GSM system on the BCCH (Broadcast Common Control Channel) subcarrier.

The network measurements illustrated are executed by terminal 14 not only on switch-on but also when the subscriber moves on with the terminal 14 in the switched-on state within the mobile radio network. The network measurements serve to determine the conditions for a cell change, for which it is required under some circumstances that the receive level of an adjacent cell is higher than the receive level of the currently used cell. On the basis of the frequency of the network measurements the measurement data read out in the inventive method produce the current position of the terminal 14 with sufficient precision. Alternatively a network measurement can also be initiated by the receipt of a measurement data request message such as the one described in greater detail below.

In accordance with the invention a further device is provided in the network 10, namely a position determination server 16 (or Location Server, LS). This calculates the position of the terminal 14, in which case no capacity for executing expensive calculations has to be reserved for terminal 14.

For the calculation the server 16 accesses the measurement data in the terminal 14 (symbolized by the arrow 17), i.e. the list of the network measurements last conducted. The list points in the example of FIG. 1 to the field strengths of the base station of cells CEL, CEL1 to CEL8 as well as the associated cell IDs. However not all the pairs (field strength/cell) listed need to be interrogated, but for example only the first three entries, i.e. those base stations with the strongest receive levels. In the example shown in FIG. 1 this relates to cells CEL 5, CEL6 and CEL8, which are symbolized by arrows 18. It frequently occurs that the receive levels of the base stations of adjacent cells are higher than those of the serving cell.

The server 16 further accesses the geographical position or coordinates of the base station of the cells of the mobile radio network 10, symbolized by the arrow 19. This request must not be directed to the base station itself but can relate to a database, as depicted in more detail below.

From the position of a base station as well as the transmit power and directional characteristic (beam form) of a base station and the strength of the field of this base station, as measured by the terminal 14, the server 16 can then use known algorithms to determine the location of a geographical area, in which the terminal 14 must be positioned. This area can take the form of a hyperbola for example. If the Location Server 16 performs this calculation for around three base stations, the terminal 14 is at the intersection point of three hyperbolas.

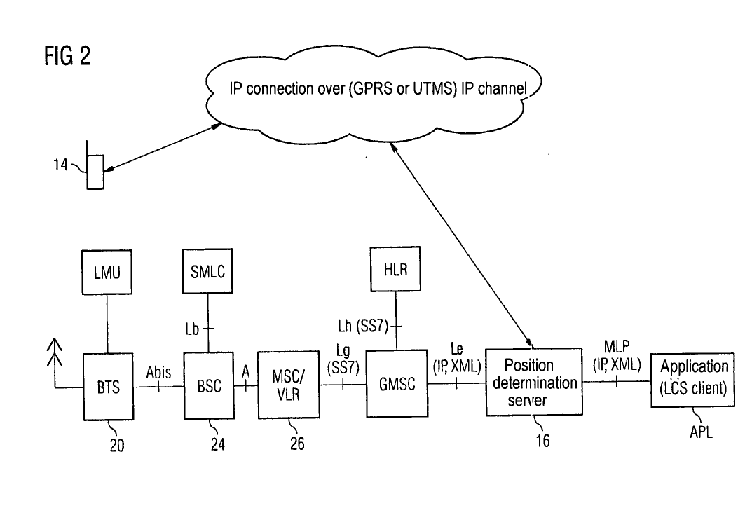

FIG. 2 shows a schematic overview of a number of important network nodes of the mobile radio network 10 from FIG. 1. To establish an IP connection between terminal 14 and position determination server 16 a radio connection between terminal 14 and a BTS 20 is required. The connection continues via a BSC 24, a central network node 26 (here a MSC/VLR) and a gateway MLC. An LMU and a Serving MLC can be connected to BTS 20 and BSC 24 as is needed with known methods for position determination.

In the example shown in FIG. 2 the classical network components BTS 20, BSC 24, MSC 26, HLR and GMLC are interconnected by means of the SS7 protocol stack. The position determination server 16 is linked in using an IP connection. In the same way data is transferred between the server 16 and a requesting software application or an LCS client APL.

The connection between terminal 14 and server 16 is based on the IP protocol, so that no SS7 stack is required at server 16. Via this connection the measurement data can be requested from the terminal and transferred from it (arrow 17 in FIG. 1).

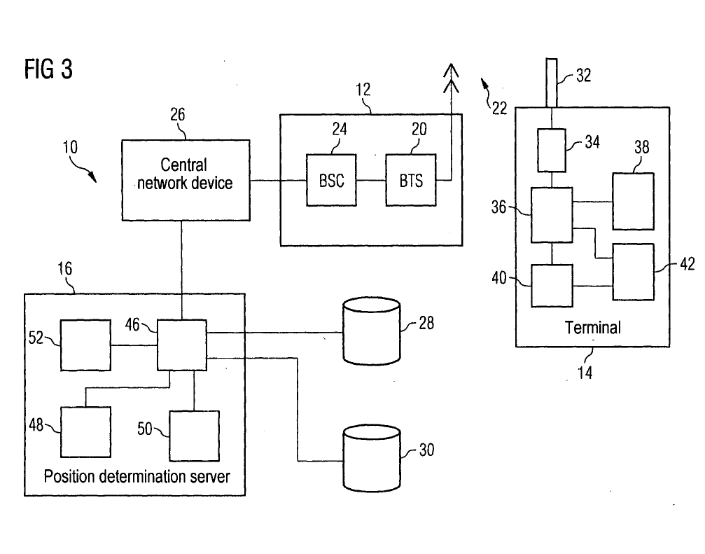

The major components of the invention shown in FIG. 1 and 2 are explained below in greater detail. FIG. 3 shows a schematic of a few nodes of the mobile radio network 10 as well as the terminal 14. The mobile radio unit 14 is connected by a radio signal to a base station 12, or, to put it more precisely, with BTS 20 of the base station 12. This should be taken to mean in very general terms the exchange of radio signals between the units 14 and 20 over a radio link 22. This also relates especially to the recording of the broadcast signals transmitted by the BTS 22 in the BCCH channel in the cell (CEL in the FIG. 1), in which the terminal 14 is located.

The base station 12 also includes the BSC (Base Station Controller) 24, as is known to the person skilled in the art. The BSC 24 is connected to further network nodes of the mobile radio network 10. In the exemplary embodiment shown in FIG. 3 a central network device 26 in particular is connected to the BSC 24. Rather than an MSC (cf. FIG. 2) this might also be an SGSN (Serving GPRS Support Node) in a GPRS or UMTS network.

Numerous further nodes can be connected to the network device 26, of which only the position determination or location server 16 is shown in FIG. 3. The server 16 in its turn has access to a database 28 or database with positions and maximum transmit powers of the base stations of the network 10. This database 28 might be present as a server within the framework of a subnetwork for the network management system of the mobile radio network 10. Further the Location Server 16 has access to a server 30 with an authentication database. The Location Servers 16 can access the database 28 and 30 directly as shown in the FIG. 3, or can access it via the central network node 26.

The position determination server 16 has a control unit 46 which controls the further units of the server, of which the major units are shown in FIG. 3. In particular a generation unit 48 to generate measurement data request messages as well as a measurement data evaluation unit 50 are present. This calculated position data of the terminal 14 can be stored in a position data memory 52, as will be described in greater detail below.

The terminal 14 has an antenna 32 for transmitting and receiving radio signals. The antenna 32 is connected to a transceiver unit 34 which forwards the received radio signals to a central control unit 36 of the terminal 10 or is controlled by the latter to transmit radio signals via the antenna 32. The control unit 36 is embodied for communication (over the radio link 12) with devices of the mobile radio network 10 and to this end controls the transceiver unit 34 in accordance with the protocols of the mobile radio standard for the mobile radio network 10.

After terminal 14 is switched on via an input unit for user commands (not shown), the control unit 36 causes a unit for network measurements 38 (Network Measurement Unit, NMU), to carry out network measurements in the way known to the person skilled in the art, as depicted in FIG. 1 above. The NMU 38 can also be a part of the central control unit 36, but for reasons of clarity is shown separately from this in FIG. 3. The result of the network measurements, a list of the measured field strengths with the associated cell identifications or cell IDs, arranged in descending order of receive level, is returned to the control unit 32 which stores this list in a measurement data memory 40.

The field strengths and cell IDs stored in the measurement data memory 40 are conventionally used to speed up a renewed network measurement when the terminal 14 is switched back on, to prepare a location update or to prepare a change of cell in idle mode or also during an ongoing voice connection.

In accordance with the invention there is also a (Location information Retrieval, LIR) measurement request function block 42 in terminal 14 which can also be a part of the control unit 32, but is shown in FIG. 3 as a self-contained block.

Terminal 14 can for example be what is known as a Java phone, that is a device of which the major functional features are implemented in the form of Java applications. A major part of the LIR function block can in this case consist of a Java application.

A Java runtime environment, for example a J2 environment, can further be implemented on terminal 14. On the basis of this technology it is particularly simple to establish IP connections in GPRS and UMTS networks over which the measurement data can then be transmitted in accordance with the invention to the location server 16.

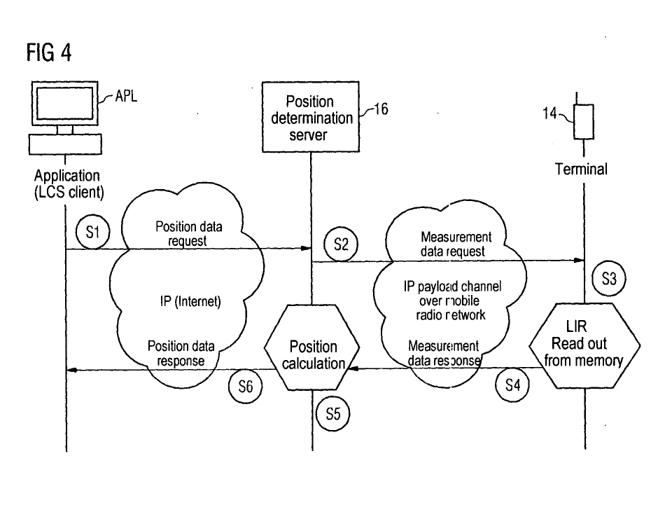

One example for the execution sequence of the method in accordance with the invention is now described on the basis of the message flow diagram in FIG. 4.

The Location Server 16 and also the terminal 14 with LIR function block are shown in FIG. 4 as the units transmitting and receiving the messages. An application APL is shown as a further unit.

The typical execution sequence shown in FIG. 4 begins with the application APL (seen by the location server 16 as an LCS client) transmitting in a step S1 a location data request message to the location server 16. Usually an IP-based Internet connection is used for this purpose. The software application APL can be located on a computer, but also on a mobile device, i.e. a mobile telephone or a computer that can be used as a mobile device. In the second case the application APL uses the same mobile Internet environment as is used for the transmission of the measurement data described below. Naturally other data transmission technologies (fixed connection, SMS, . . . ) could also be used. The application APL can for example be made to generate and transmit the location data request through a user request. However the initiator can also be an automatically generated action e.g. a cyclic monitoring. The person skilled in the art is familiar with these types of initiation; The details of the type of initiator are of no importance for the invention.

As a result of step S1 the location data request message sent by the application APL is received in the server 16. In step S2 the location server 16 reacts to the received message by transmitting a measurement data request message to the terminal 14 to be localized, more precisely to the measurement request function block 42. To do this the server 16 initially establishes a connection. This is provided by default in a known mobile radio network 10, based for example on the GPRS/UMTS standard, and the details of this connection setup will thus not be discussed in any greater detail here. Terminal 14 can be a Java phone on which a Java runtime environment (for example in accordance with the J2ME technology) is implemented. Such a device is also provided for setting up the IP connections, so that no further details will be given here.

The request message send over the IP connection to terminal 14 for requesting the measurement data is created in the generation unit 48 of the location server 16 (this and the following reference symbols relate to FIG. 3) and sent via the control device 46 of the server.

The request message reaches the terminal 14 via the radio link 20 and is transmitted via the receiver unit 34 to the central control unit 36 of the terminal. This performs a preliminary evaluation of the received request message and directs the request to the measurement request function block 42. This (step S3) is made to read out the list of the last measured field strengths of the surrounding base stations from the measurement data memory 40.

In this case different embodiments of the request message or of the reaction of the measurement request function block 42 to the request message are conceivable. Thus for example the message might contain a parameter which specifies how many receive levels are to be read out with the associated cell IDs, for example only the strongest three, or all those contained in the list. It is also conceivable to evaluate a parameter which, in accordance with the privacy settings (data protection), before reading out the measurement data outputs a message or interactive request to the user of the mobile telephone (via its display) and then supplies the data according to the reaction of the user. Finally a parameter could be included which makes terminal 14 perform a new network measurement in order to obtain the very latest measurement data.

The measurement data read out in step S3 is assembled by the measurement request function block 42 into a measurement data response message. This is transferred from the measurement request function block 42 to the central control unit 36. Together with the destination address, i.e. the address of the location server 16, and the associated request reference the response message is then transferred in step S4 over the existing IP connection and the radio link 20 to the server 16.

In the exemplary embodiment of FIG. 4 the messages are transferred in step S2 and S4 over IP protocol connections. Naturally another transport protocol can be used over the radio payload channel for this.

Step S4 ends with the response message being received and (pre-)evaluated in the control unit 46 of the location server 16. As a reaction to the fact that a measurement data response message is involved, this is forwarded to the measurement data evaluation unit 50. Here the measurement data supplied by the terminal 14 is extracted and buffered if necessary.

To determine the position of terminal 14 in step S5 on the basis of the field strengths or receive levels of the surrounding base stations, information relating to the relationship between base station-related field strengths and the assigned geographical coordinates is necessary. To this end evaluation unit 50 has read access to a database server 28. The database server 28 contains a list of base stations of the mobile radio network 10, for example all base stations or the base stations of a geographical region. For each base station the cell ID, the geographical position and the maximum transmit power with which the base station transmits on the BCCH are recorded. Furthermore information about the orientation (beam) of the base station is available. The server 28 might be a part of a subnetwork of the mobile radio network 10 which is used for network planning and for the network management data, but might also contain a collection of data derived from this database and for example enhanced by reference measurements. In this case it would be possible to ensure the currency of the data in the database 28 through a corresponding administration or software update.

The location of the terminal can be calculated from the positions of the base stations, their transmit power as well as the measured field strengths of each base station. The algorithms to be used for this are based on the attenuation and propagation of electromagnetic wave carrier waves and are known (and are for example also included for calculating the network structures). As a result of the position determination the evaluation unit 50 transfers the calculated position of the terminal 14, if necessary supplemented by information about the accuracy of the position, i.e. on the margin of error (“±30 m in East-West direction, ±10 m in North-South direction”) to the control unit 46.

In a step S6 the calculated position data is transferred from the position determination server 16 to the application APL on the terminal 14. This can be done on the basis of the same connection technology as with the position data request, usually via IP.

The position data received by the application APL on the terminal 14 is then further processed in accordance with the precise purpose of this application.

The example shown in FIG. 4 can be modified by using suitable protocols. This means that it is conceivable for example for the terminal to be localized to transmit its measurement data on request cyclically, automatically and asynchronously to the position determination server, which then stores the results for subsequent calldown by applications (Example: Vehicle tracing). Also possible is the timed position interrogation by the position determination server in response to a corresponding position data request message from a software application (triggering request).

Furthermore the server 16 can advantageously be set up to check the authorization data of the requesting device or application. To do this a corresponding authentication checking message can be transferred to an authentication or registration database 30 (cf. FIG. 3). If an application is represented by an entry in the database 30, for example with an application name, an IP address and if nec. a password, the outcome of the checking of the registration or authentication is positive. The result of the check is returned in a check response message to the position determination server 16. In the example shown in FIG. 4 the authorization of the application APL would have to be checked (not shown in the FIG. 4).

Only one position determination is ever shown in the Figures. Naturally a number of these servers, which might relate to specific geographical regions or subscribers, can be present in the mobile radio network.

The description given here is to be taken as an example and is not intended to restrict in any way the inventive framework which is specified by the claims given below.

1.-18. (canceled)

19. A method of determining the position of a terminal in a cellular mobile radio network using network measurements to determine a service cell, the method comprising:
transferring a measurement data request to the terminal by a position determining server;
reading out of measurement data acquired by the network measurements from a measurement data memory included in the terminal in response to the measurement data request;
transmitting a measurement data response including the measurement data to the position determining server by the terminal; and
determining the position of the terminal based on the measurement data by the position determining server.

20. The method according to claim 19, wherein the measurement data request and/or the measurement data response are transmitted via a data channel of a common carrier of the mobile radio network.

21. The method according to claim 19, wherein reading out the measurement data is time-controlled.

22. The method according to claim 21, wherein the measurement data are read out once or repeatedly.

23. The method according to claim 19, wherein the measurement data are read out based on data protection settings set by a user of the terminal.

24. The method according to claim 19, wherein the measurement data represent a field intensity of at least one fixed part of the mobile radio network.

25. The method according to claim 19, wherein the measurement data represent a cell ID of a cell serviced by a fixed part of the mobile radio network, the cell ID and a field intensity of the fixed part jointly stored in the measurement data memory.

26. Method according to claim 19, wherein the measurement data include information related to such cell within which the terminal is currently located.

27. The method according to claim 19, wherein the measurement data include information related to such cells adjacent to the cell within which the terminal is currently located.

28. The method according to claim 19, wherein determining the position of the terminal includes position information related to a fixed part of the mobile radio network serving the cell within which the terminal is currently located.

29. The method according to claim 19, wherein determining the position of the terminal includes position information related to fixed parts of the mobile radio network serving cells adjacent to the cell within which the terminal is currently located.

30. The method according to claim 19, wherein the measurement data are transmitted from the terminal to the position determining server using an IP connection.

31. The method according to claim 19, wherein the determined position of the terminal is queried from the position determining server using an access request, the access request checked for access authorization by the position determining server.

32. The method according to claim 19, further including transmitting information related to the determined position to the terminal or to a requesting software application.

33. A device for determining the position of a terminal in a cellular mobile radio network, comprising:
a measuring unit adapted to determine a service sell using network measurements and included in the terminal;
a measurement data memory for buffering measurement data acquired by the network measurements;
a measurement request unit for retrieving the measurement data, the measurement request unit included in the terminal; and
a position determining server, wherein
the measurement request unit is adapted to:
process a measurement data request received from the position determining server;
read out the measurement data from the measurement data memory in response to the processing of the measurement data request;
generate a measurement data response related to the read out measurement data; and
transmit the measurement data response to the position determining server, and
the position determining server is adapted to:
generate and transmit the measurement data request to the terminal;
receive and process the measurement data response transmitted from the terminal including retrieving the measurement data from the measurement data response; and
determine the position of the terminal based on the measurement data.

34. The device according to claim 33, wherein the measurement data represent a field intensity of at least one fixed part of the cellular mobile radio network and a cell ID of such cell serviced by the fixed part.

35. The device according to claim 33, wherein the position determining server is further adapted to:
access or determine position information related to fixed parts of the cellular mobile radio network; and
determine the position of the terminal based on position information related to fixed parts.

36. The device according to claim 34, wherein the position determining server is further adapted to:
access or determine position information related to fixed parts of the cellular mobile radio network; and
determine the position of the terminal based on the field intensity.

37. The device according to claim 33, wherein the measurement request unit is adapted to send or receive the measurement data request and/or the measurement data response over an IP connection.

38. The device according to claim 33, wherein the measurement request unit utilizes a Java application for retrieving the measurement data.

39. The device according to claim 38, wherein the terminal includes a Java runtime environment for executing the Java application.

40. The device according to claim 33, wherein the position determining server is further adapted to check an access request for access authorization in response to a position data request received by the position determining server.

41. The device according to claim 40, wherein the position data request includes a request for transmitting the determined position of the terminal by the position determining server to a requesting application.
